(19) United States
(12) Patent Application Publication
(10) Pub. No.: US 2009/0065030 A1
(43) Pub. Date: Mar. 12, 2009

(54) Washer and method of performing spinning operation

(76) Inventor: Ki Hyeong Do, Changwon-si (KR)

Correspondence Address: MCKENNA LONG & ALDRIDGE LLP, 1900 K STREET, NW, WASHINGTON, DC, 20006, US

(21) Appl. No.: 12/289,527

(22) Filed: Oct. 29, 2008

Related U.S. Application Data
(63) Continuation of application No. 10/885,928, filed on Jul. 6, 2004.

(30) Foreign Application Priority Data
Aug. 26, 2003 (KR) P 2003-59059

(51) Int. Cl. B08B 7/00; D06F 33/02

(52) U.S. Cl. 134/33; 68/12.12

(57) ABSTRACT

A washer and a method of performing a spinning operation are disclosed. The washer includes a tub which stores clothes to be washed, and a motor which rotates the tub. It also includes a microprocessor which generates a pump driving signal having duty ratios to power on and off a drain pump during at least one preliminary and a main sub-cycles of a selected spinning operation. The method of performing the spinning operation includes accelerating, decelerating, and maintaining a certain speed during the at least one preliminary sub-cycle of the spinning operation. However, the main sub-cycle includes accelerating and maintaining another certain speed. According to the principles of the present invention, the washer and the method of performing the spinning operation prevent the drain pump from not only overheating but also creating power loss.

### CROSS-REFERENCE TO RELATED APPLICATIONS

This application claims the benefit of Korean Application No. P2003-59059, filed on Aug. 26, 2003, which is hereby incorporated by reference.

### BACKGROUND OF THE INVENTION

1. Field of the Invention

The present invention relates to a washer, and more particularly, to a drum washer and a method for performing a spinning operation of the same.

2. Discussion of the Related Art

Generally, a washer performs washing by executing washing, rinsing, and spinning operations. Washers may be categorized into a pulsator, an agitator, a drum type, and the like based on how the washing operation performs.

Referring to FIG. 1, a body 1 includes a tub 2 inside of the body 1, which is connected by a damper (not shown in FIG. 1). Dirty clothes to be washed are placed in the tub 2, and a driving force of a motor 10 is transmitted through a belt 11, which rotates a drum 3. In the mean time, water is added through an inlet pipe 6 while a thermometer 4 (e.g., thermistor) measures a temperature. The water is drained by a drain pump 8 through a drain pipe 7, which is connected between the tub 2 and the pump 8. Finally, the water exits to the outside through a drain hose 9, attached from the pump 8 to the outside.

Utilizing the washer illustrated previously, a user opens the door provided (not shown in the FIG. 1) on the front side of the body 1. After inserting the dirty clothes into the tub 2, the user commands a washing operation by selecting a washing option on the control panel displayed on the washer. As a controller in the washer senses a load weight and determines an amount of water, the water is supplied with a detergent from the detergent box 5, flows through the inlet pipe 6, and reaches the inside of the tub 2.

When a level of the water in the drum 3 reaches a desired level, the motor 10 starts to rotate so that the drum 3 spins. After the washing operation, the pump 8 is turned on to drain the supplied water from the tub 2. The water flows through the drain pipe 7 and the drain hose 9, and exits to the outside. After this washing operation, the rinsing and spinning operations are executed. Finally, the whole washing process is completed.

However, according to the principles of the related art, the drain pump 8 has not only created a considerable amount of power loss but also been easily overheated. It is realized that the supplied water does not consistently flow out to the outside during the spinning operation. Clothes such as a towel which soaks in much moisture by nature force some of the water to remain inside the tub 2 instead of flowing out to the outside. Therefore, it is a waste of the power if the drain pump is turned on for the entire spinning operation. It also causes the drain pump to be overheated for draining the air instead of the water.

Therefore, according to the principles of the present invention, the method of performing a spinning operation is improved by powering on and off the drain pump for a certain amount of time during the spinning operation having at least one preliminary and a main sub-cycles. The washer, now, drains the water more efficiently.

### SUMMARY OF THE INVENTION

Accordingly, the present invention is directed to a washer and a method of performing a spinning operation that substantially obviates one or more problems due to limitations and disadvantages of the related art.

An object of the present invention is to provide a method of performing a spinning operation, which prevents a drain pump from not only overheating but also creating power loss.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a method of performing a spinning operation according to the present invention may include initiating a selected spinning operation including at least one preliminary and a main sub-cycles after performing a washing operation. It also may include generating a pump driving signal having at least two different duty ratios and assigning one of the two different duty ratios to each of the at least one preliminary and a main sub-cycles to power on and off a drain pump.

In another aspect of the present invention, a washer includes a tub containing clothes to be washed, a motor to rotate the tub, and a drain pump to drain water from the tub after a washing operation. It also includes a microprocessor, which generates a pump driving signal having at least two different duty ratios to power on and off the drain pump.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings;

FIG. 1 illustrates a front view of an existing drum washer;

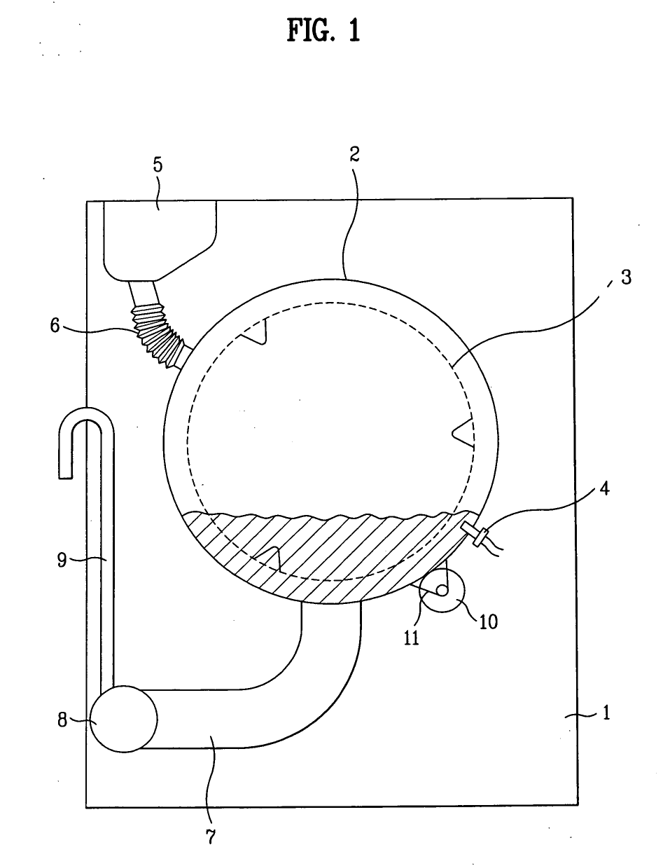

FIG. 2 illustrates a schematic block diagram for a drum washer in accordance with the present invention;

FIG. 3a is a flow chart illustrating a method of performing a spinning operation for a washer according to the present invention;

FIG. 3b is a continuation of the flow chart illustrating the method of the spinning operation for the washer according to the present invention;

FIG. 4 illustrates a graph showing how a motor and a drain pump perform in terms of time during the spinning operation.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

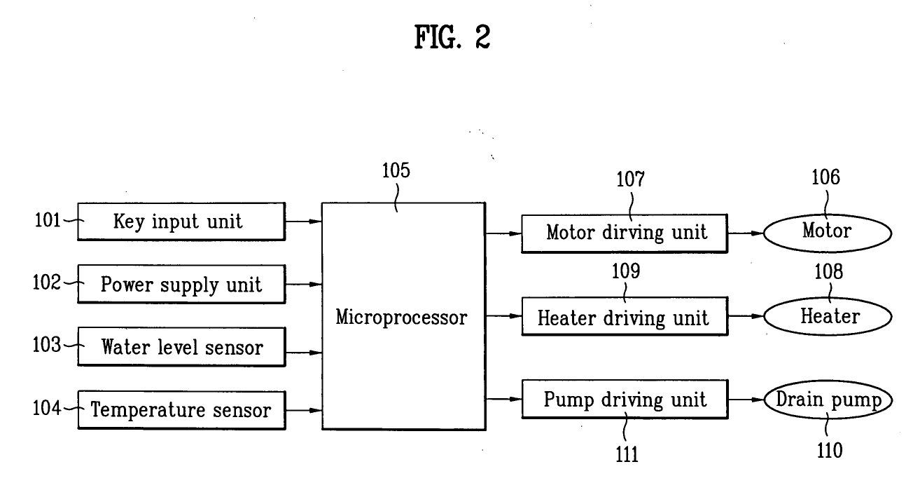

FIG. 2 illustrates a schematic block diagram for a drum washer in accordance with the present invention. The drum washer includes a key input unit 101, which receives a command for a washing process from a user, and a microprocessor 105, which determines a washing operation, based on selected washing parameters. In addition, the microprocessor 105 generates a pump driving signal having duty ratios to power on and off a drain pump 110 on a regular basis during a selected spinning operation. The washer also includes a pump driving unit 111 which drives the drain pump 110 dependent upon the pump driving signals.

The washer further includes a water level sensor 103 which senses a level of water in a tub 2, and a temperature sensor 104 which adjusts temperature in the tub 2, according to the control signals from the microprocessor 105. The washer further includes a power supply unit 102 which supplies the power throughout the system, a motor driving unit 107 which drives a motor 106, and a heater driving unit 109 which adjusts a heater 108, by means of receiving the control signals from the microprocessor 105.

According to the washer with the present invention, when a user commands washing by inputting a washing option displayed on the control panel on the washer, the microprocessor 105 determines a washing operation based on selected washing parameters such as a load weight of clothes in the tub 2 and a level of the supplied water. The washing operation precedes the spinning operation, which includes at least one preliminary and a main sub-cycles. After the washing operation, according to the principles of the present invention, the microprocessor 105 generates the pump signal having duty ratios to power on and off the drain pump 110 for a certain amount of time during the at least one preliminary and a main sub-cycles, and power it on for the rest of the spinning operation. However, the drain pump 110 remains on for the entire spinning operation in accordance with the related art.

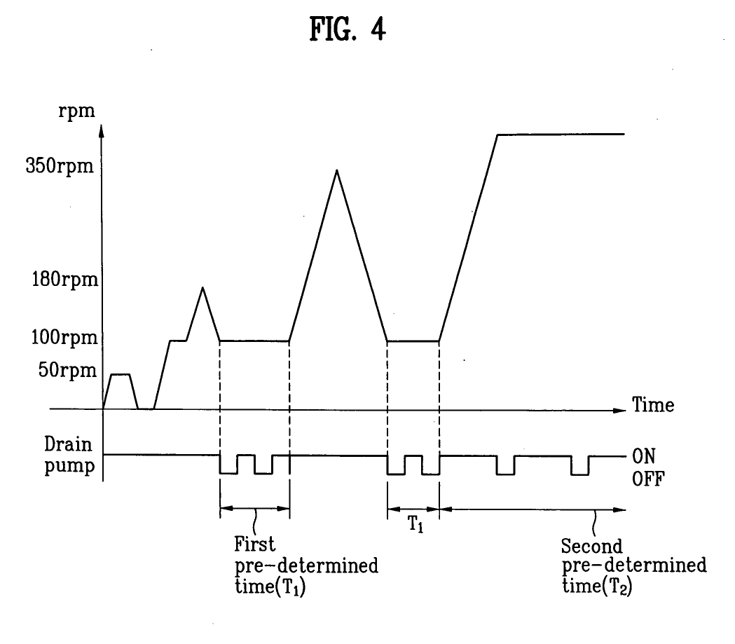

FIG. 4 illustrates a graph showing how the motor and the drain pump perform in terms of time during the spinning operation. The spinning operation includes at least one preliminary and a main sub-cycles. The at least one preliminary sub-cycle of the spinning operation includes accelerating, decelerating, and maintaining a certain speed. However, the main sub-cycle only includes accelerating and maintaining another certain speed. For instance, according to FIG. 4, there are a first sub-cycle and a second preliminary sub-cycle and a third main sub-cycles. During the first sub-cycle, the motor 106 accelerates to a first speed (180 RPM), decelerates back to a second speed (100 RPM), and maintains the second speed for a first pre-determined time. Then, the second sub-cycle includes accelerating the motor 106 from the second speed (100 RPM) to a third speed (350 RPM), decelerating back to the second speed (100 RPM), and maintaining the second speed for the first pre-determined time. Now, a main sub-cycle, the third sub-cycle, is performed. During the third sub-cycle, the microprocessor 105 accelerates the motor to over the third speed (350 RPM) and maintains the speed for a second pre-determined time. The second pre-determined time for the third sub-cycle is apparently longer than the first pre-determined time for the first sub-cycle and the second sub-cycle.

In addition, the drain pump 110 starts to rotate as soon as the spinning operation begins. When the speed of the motor 2 remains at the second speed (100 RPM) for the first pre-determined time during the first sub-cycle and the second sub-cycle, the microprocessor 105 generates the pump driving signal having a first duty ratio to power on and off the drain pump 110. When the speed of the motor 2 remains at over the third speed (350 RPM) for the second pre-determined time, the microprocessor 105 generates the pump driving signal having a second duty ratio to power on and off the drain pump 110. For the rest of the spinning operation, the drain pump 110 is constantly powered on to drain the water. The second duty ratio is apparently greater than the first duty ratio. Yet, the generated pump driving signal during the pre-determined times may have the same duty ratios but different frequencies.

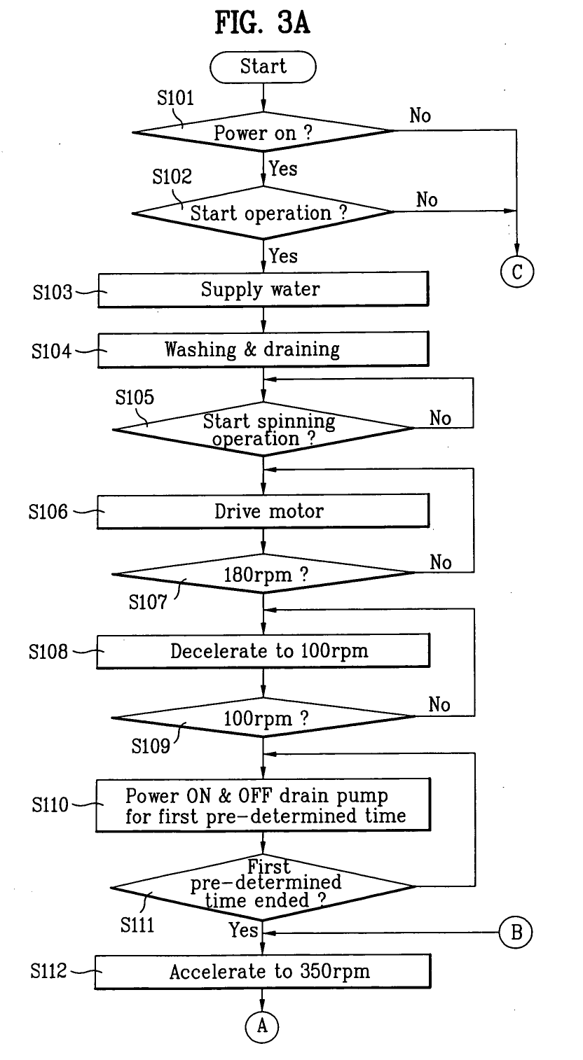

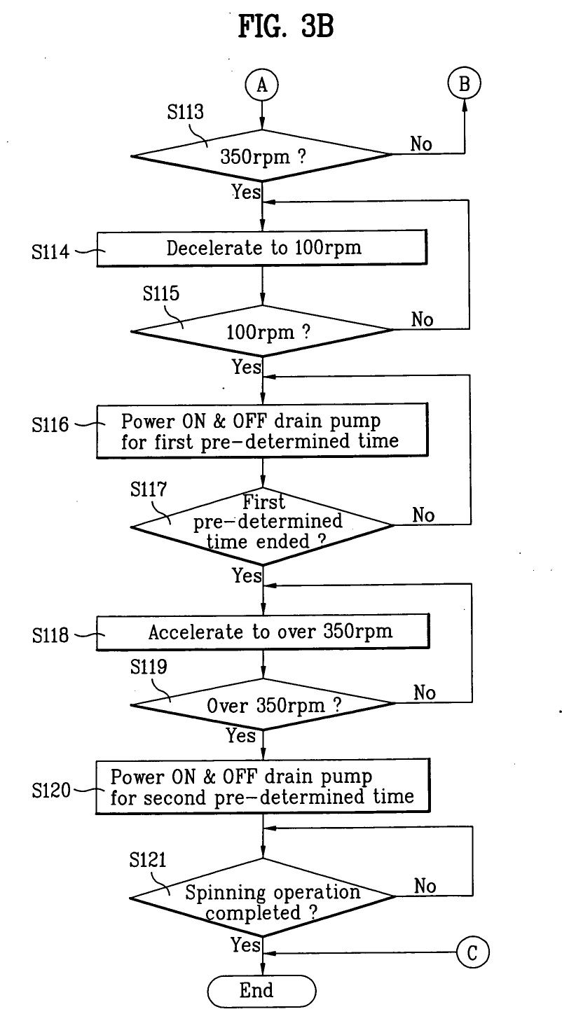

FIG. 3a is a flow chart illustrating a method of performing a spinning operation from a tub in a washer, and FIG. 3b is a continuation of the flow chart of FIG. 3a according to the present invention. When the microprocessor 105 determines whether the washer is powered on (S101), it senses and executes a user's washing command (S102). It then supplies water to the tub 2 (S103), performs a washing operation, and drains the water based on the selected parameters (S104).

After draining, the microprocessor 105 determines whether the spinning operation has begun. (S105). If so, the microprocessor 105 drives the motor 106 and the drain pump (S106), and determines if the motor 106 reaches 180 RPM (S107). If so, it decelerates the motor 106 to 100 RPM (S108). If the motor 106 maintains 100 RPM (S109), the microprocessor 105 generates the pump driving signal having the first duty ratio to power on and off the drain pump 110 for the first pre-determined time (S110).

If the first pre-determined time ends (S111), the microprocessor 105 operates the drain pump at a constant speed and accelerates the motor 106 to 350 RPM (S112). If the speed reaches 350 RPM (S113), the microprocessor 105 decelerates the motor 106 back to 100 RPM (S114). If it reaches 100 RPM (S115), the microprocessor 105 generates the pump driving signal having the first duty ratio to power on and off the drain pump 110 for the first pre-determined time (S116). If the first pre-determined time ends (S117), the microprocessor 105 operates the drain pump 110 back at the constant speed, and accelerates the motor 106 to over 350 RPM (S118). If it reaches over 350 RPM (S119), the microprocessor 105 generates the pump driving signal having the second duty ratio to power on and off the motor 106 for the second pre-determined time (S120). The microprocessor 105 finally determines whether the spinning operation is completed (S121). If so, the entire washing process terminates.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

1-11. (canceled)

12. A method of performing a spinning operation of a washer having a drain pump and a wash basket motor, the method comprising:
driving the wash basket motor, the wash basket motor continuously driven during the spinning operation; and
driving the drain pump, the drain pump selectively driven during the spinning operation.

13. The method of claim 12, wherein the spin operation includes maintaining a speed of the wash basket motor in a predetermined speed for a predetermined time and the drain pump repeats on and off during the maintaining step.

14. The method of claim 13, wherein the maintaining step includes a first maintaining step and a second maintaining step, an on/off period of the drain pump in the second maintaining step is larger than an on/off period of the drain pump in the first maintaining step.

15. The method of claim 12, wherein the spin operation includes at least one preliminary sub-cycle and a main sub-cycle.

16. The method of claim 15, wherein the at least one preliminary sub-cycle includes a first sub-cycle, the first sub-cycle comprising accelerating the wash basket motor to a first speed, decelerating the wash basket motor to a second speed, and maintaining the second speed for a first pre-determined time.

17. The method of claim 16, wherein the at least one preliminary sub-cycle further includes a second sub-cycle, the second sub-cycle comprising accelerating the wash basket motor to a third speed, decelerating the wash basket motor to the second speed, and maintaining the second speed for the first pre-determined time.

18. The method of claim 17, wherein the main sub-cycle includes rotating the wash basket motor from the second speed to the third speed, and maintaining the third speed for a second pre-determined time.

19. The method of claim 18, wherein the drain pump repeats on and off during the maintaining steps of the first sub-cycle, the second sub-cycle and the main sub-cycle.

20. The method of claim 19, wherein an on/off period of the drain pump in the main sub-cycle is larger than an on/off period of the drain pump in the first and second sub-cycles.

21. A washer comprising:
a drum containing clothes, the drum rotatably mounted in a tub;
a motor rotating the drum to perform a spinning operation;
a drain pump draining water from the tub; and
a microprocessor controlling the motor and the drain pump, the microprocessor continuously driving the motor and selectively driving the drain pump during the spinning operation.

22. The washer of claim 22, wherein the microprocessor controls the motor to maintain a speed of the motor in a predetermined speed for a predetermined time during the spinning operation and controls the drain pump to repeat on and off for the predetermined time.
